(19) United States
(12) Patent Application Publication
(10) Pub. No.: US 2005/0128908 A1
(43) Pub. Date: Jun. 16, 2005

(54) Apparatus and method of determining optimal velocity for recording on optical disc

(75) Inventors: Jung-mook Shin, Seoul (KR); Myung-su Han, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/011,033

(22) Filed: Dec. 15, 2004

(30) Foreign Application Priority Data
Dec. 16, 2003 (KR) 2003-91898

(51) Int. Cl. G11B 5/09

(52) U.S. Cl. 369/47.38; 369/53.3

(57) ABSTRACT

An apparatus and a method of determining an optimum recording speed for a medium in a disc drive device, the method includes inserting a medium into the disc drive device, determining when disc characteristic information, including a manufacturer code and a type code indicating recording characteristics of the medium, is registered in the disc drive device; and when the disc characteristic information is not registered in the disc drive device, controlling maximum recording speed and target optimum power control power for recording on the medium, according to the type code of the medium.

### CROSS-REFERENCE TO RELATED APPLICATIONS

This application claims priority from Korean Patent Application No. 2003-91898 filed on Dec. 16, 2003, in the Korean Intellectual Property Office, the disclosure of which is incorporated herein by reference.

### BACKGROUND OF THE INVENTION

1. Field of the Invention

The present invention relates to an apparatus and a method of driving an optical disc, and more particularly, to an apparatus and a method of determining an optimum recording velocity for an optical disc according to whether a recording characteristic of the optical disc has been changed.

2. Description of the Related Art

Data is recorded on an optical storage medium, e.g. an optical disc, by forming marks on tracks of the optical disc. Optical discs capable of recording, erasing, and reproducing include 650 MB CD-R/RW, 4.7 GB DVD-RAM/R/RW, 4.7 GB DVD+RW, etc., as well as media being developed, such as 23+GB HD-DVD.

A CD-R has pits formed on its recording layer by applying pigments and melting them with a laser. For example, in a CD-RW disc, a phase transformation film that can be transformed between a crystalline state and a non-crystalline state is applied on the recording layer of the CD-RW disc, and marks are formed by phase transforming the film. In order to optimize the recording/reproduction characteristics of such recordable discs, a variety of technologies, often referred to as write strategies, have been introduced.

A write strategy suitable for a disc is determined in advance and, in turn, recorded in firmware of a disc drive. When the disc is inserted into the disc drive, the disc drive reads absolute time in pregroove (“ATIP”) information regarding disc identification codes from the disc to distinguish a manufacturer and/or a recording characteristic of the disc, and then selects an appropriate write strategy for the disc from among various write strategies stored in the disc drive according to the read information.

If the disc drive does not include any write strategy corresponding to the disc, the disc drive may choose a default write strategy or a write strategy for a different disc with similar recording characteristics provided by the same manufacturer. Generally, different default write strategies are established for different disc materials. In the case where a write strategy for a different disc with similar recording characteristics provided by the same manufacturer is chosen for the disc, a speed for recording on the disc is also determined by the disc drive according to the chosen write strategy. Thus, for example, the disc drive may record on the disc at a high speed which is an optimum speed according to the write strategy. However, if the disc has different recording characteristic from which the write strategy is designed, the high recording speed may lead to s poor recording quality.

Since different types of discs need to be driven at different velocities, indiscriminately applying a write strategy to a disc may result in a recording and/or reproduction error or failure, a power adjustment error, or poor recording quality, among other problems.

### SUMMARY OF THE INVENTION

The invention provides a method of determining an optimum recording velocity for an optical disc, in which an uppermost speed for driving the disc is restricted and power for driving the disc is adjusted according to a recording characteristic of a disc, such that no optimum power control error occurs, thereby maintaining recording quality and satisfying a user.

According to an aspect of the invention, there is provided a method of determining an optimum recording speed for a disc in a disc drive, the method including: when a medium is inserted into the disc drive, determining if characteristic information of the medium, which includes a manufacturer code and a type code indicating recording characteristics of the medium, is registered in the disc drive device; and when the disc characteristic information is not registered in the disc drive device, controlling maximum recording speed and target optimum power control (OPC) power for recording on the medium according to the type code of the medium.

According to an aspect of the invention, when the type code of the medium is determined to be upgraded, the maximum recording speed is set to a level that is a predetermined set recording speed.

According to an aspect of the invention, when the type code of the medium is determined to be enhanced, the target OPC power is set to a level that is less than or equal to a predetermined set OPC power.

According to an aspect of the invention, when the type code of the medium is not found to be enhanced, the maximum recording speed is set to a level that is less than a predetermined set recording speed.

According to an aspect of the invention, when the type code of the medium is not found to be enhanced, the target OPC is set to a level that is greater than or equal to a predetermined set OPC power.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view showing representative areas of a CD-R disc;

FIG. 2 is a flow chart illustrating a conventional method of determining a write strategy for an optical medium; and

FIG. 3 is a flow chart illustrating a method of determining an optimum velocity for an optical medium according to the invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

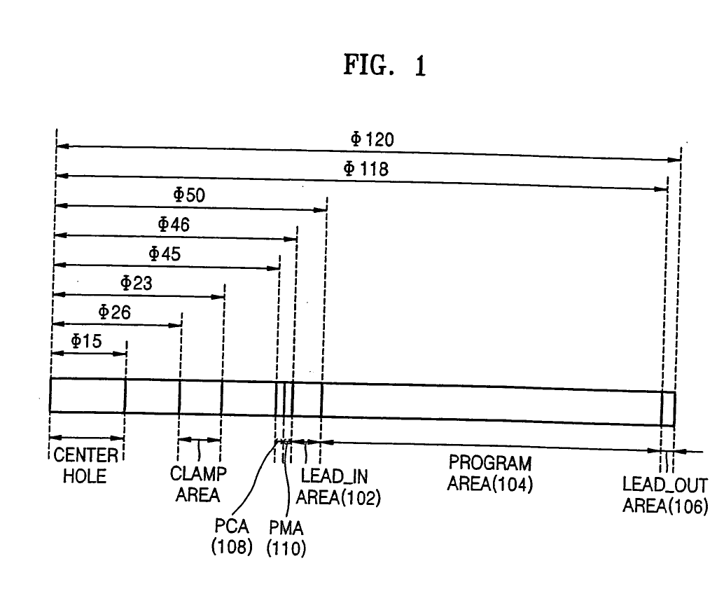

FIG. 1 is a cross-sectional view showing representative areas of a medium, such as a CD-R disc. The medium includes a lead-in area 102, a program area 104, and a lead-out area 106.

The lead-in area 102 includes absolute time in pre-groove (ATIP) information regarding medium type, medium size, channel bit length, medium structure, recording power, etc. A power calibration area (“PCA”) 108 is located toward a center area of the medium from the lead-in area 102. In the PCA, operations are performed, such as a test drive for optimum power control (OPC) is performed. A program memory area (“PMA”) 110 is also located toward the center area of the medium. In the PMA 110, much information is arbitrarily recorded, such as a recording position of information, information type, etc., while the information is being recorded in the program area 104.

The ATIP information represents medium features, such as, entire memory capacity, relative speed, intended use for data or for audio, manufacturer, etc., which is typical information for identifying the type of medium, such as whether the medium is a CD-R or a CD-RW. For example, when a medium is inserted into a disc drive, the disc drive reads ATIP information from the medium and determines various features of the medium. However, when the disc drive fails to correctly read the ATIP information, the disc drive may not accurately or sufficiently recognize the medium.

One method of distinguishing and operating media that is manufactured by different manufacturers is by using a disc identification code arranged by Technical Working Group-1 of CDs21 solutions (CDs21). This code enables compatibility between a disc drive and various types of discs or media.

The disc identification code is represented by Lead-In Start Time and Last Possible Lead-Out Start Time of ATIP information. The disc identification code includes, for example, a manufacturer code (“M code”) and a type code (“T code”).

The M code, which is used by the disc drive to recognize a manufacturer of the medium, is represented by minute digits, second digits and a first digit of frame digits of Lead-In Start Time.

Table 1 shows examples of M code.

TABLE 1

| Manu- | | |
|---|---|---|
| facturer | First Code | Second Code |
| A | 97 m 14 s 30 f-97 m 14 s 39 f | 97 m 40 s 20 f-97 m 40 s 29 f |
| B | 97 m 14 s 40 f-97 m 14 s 49 f | 97 m 41 s 20 f-97 m 41 s 39 f |
| C | 97 m 15 s 10 f-97 m 15 s 19 f | 97 m 40 s 50 f-97 m 40 s 59 f |

Referring to “97m14s30f” of Lead-In Start Time, the minute digits correspond to 97, the second digits correspond to 14, and the first digit of frame digits corresponds to 3, which together indicate a particular manufacturer “97-14-3”. Therefore, a specific code can be assigned to each manufacturer.

The first code in Table 1 is used for constant linear velocity (“CLV”) 1.2 m/s, and the second code is used for CLV 1.4 m/s.

The T code represents recording characteristics of the medium, and is divided into at least T1 and T2 codes.

The T1 code is represented by a second digit of a frame of Lead-In Start Time in ATIP. For example, in Table 1, “0” from the first code of manufacturer A, 97m14s30f, and “9” from the second code of the same, 97m14s29f, correspond to the T1 code. The T1 code is also referred to as a Master Type code, which is a parent code of the T2 code.

For example, a T1 code ranging from 0 through 4 represents a long strategy type media, for example, Cyanine-type media, while T1 code ranging from 5 through 9 represents a short strategy type media, for example, Phthalocynine-type media. Cynanine type media and phthalocynine-type media have different requirements for writing lasers. For example, phthalocynine-type media is less compatible with most conventional writing lasers than cyanine-type media.

The T1 code of a medium, ranging from 0 through 9, is set by a manufacturer of the medium in consideration of important medium characteristics, so that a disc drive can drive the medium properly.

The T2 code is represented by a second digit of a frame of Last possible Lead-Out Start Time in ATIP. The T2 code is also referred to as a Sub-Type Code, which is a daughter code or subcode of the T1 code.

The T2 code of a medium, ranging from 0 through 9, is also set by the manufacturer of the medium in consideration of medium characteristics that are less important than the characteristics associated with the T1 code.

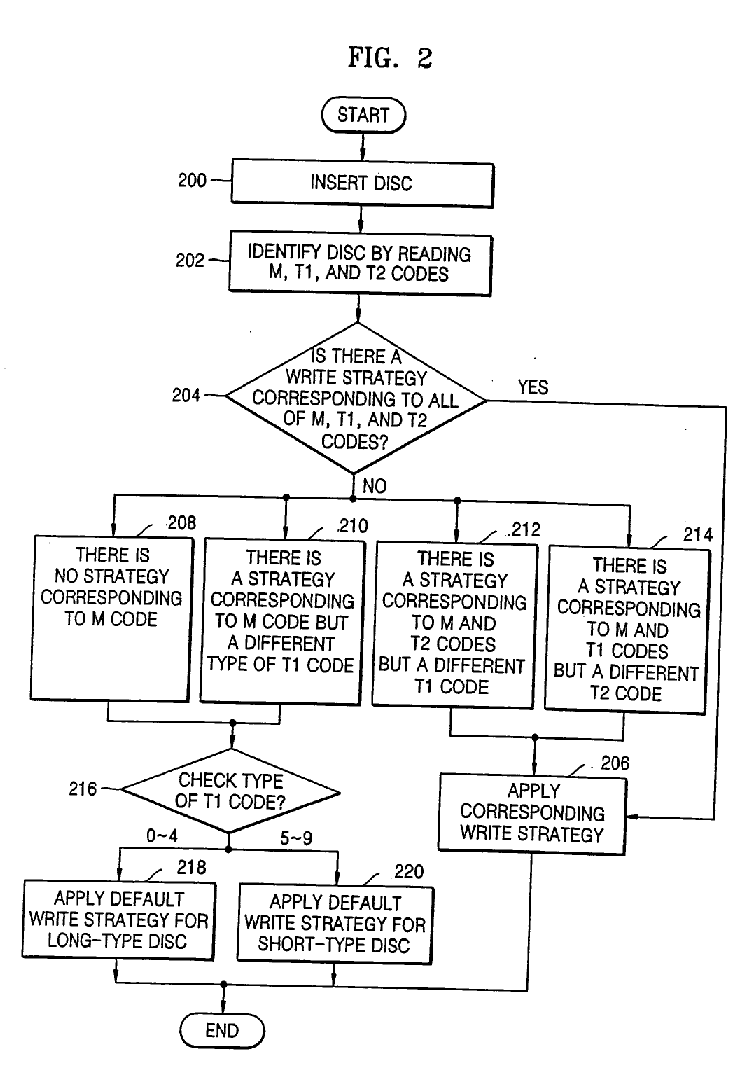

FIG. 2 is a flowchart illustrating a conventional method of determining a write strategy of an optical disc.

Firmware of a disc drive generally includes a variety of write strategies for well-known media, each write strategy having M, T1, and T2 codes that correspond to certain characteristics of the medium.

A medium, such as a disc, is inserted into the disc drive in operation 200.

The disc drive reads an M code, a T1 code, and a T2 code from the medium to identify the type of medium in operation 202.

The disc drive determines whether the M, T1, and T2 codes are included in the firmware in operation 204. When all three of the codes are included in the firmware, the disc drive selects a corresponding write strategy for recording on the medium in operation 206.

When all three of the read codes are not included in the firmware, the disc drive sets a write strategy according to one of the following four scenarios:
1) Scenario 1—there is a write strategy corresponding to the same M and T1 codes but a different T2 code in the firmware, as shown in operation 214.
2) Scenario 2—there is a write strategy corresponding to the same M and T2 codes but a different T1 code in the firmware, and the different T1 code is the same type as the T1 code read from the disc, as shown in operation 212.
3) Scenario 3—there is a write strategy corresponding to the same M code but a different T1 code in the firmware, and the different T1 code is different type from the T1 code read from the disc, as shown in operation 210.
4) Scenario 4—there is no write strategy corresponding to the same M code in the firmware, as shown in operation 208.

If scenario 1 or 2 applies, the disc drive applies the existing write strategy to drive the disc, as shown in operation 206.

If scenario 3 or 4 applies, the disc drive determines the type of T1 code read from the disc, as shown in operation 216. When the T1 code is in the range of 0 through 4, the disc drive selects and applies a default write strategy of the long-strategy type disc to drive the inserted disc, as shown in operation 218. When the T1 code is in the range of 5 through 9, the disc drive selects and applies another default write strategy of the short-strategy type disc to drive the inserted disc, as shown in operation 220.

As shown in FIG. 2, according to the conventional method of determining a write strategy, the disc drive reads M, T1, and T2 codes from the disc and applies a write strategy by selecting a corresponding write strategy from the firmware of the disc drive when the same M code and one of the T1 or T2 code is included in the write strategy. Alternatively, the disc drive distinguishes the type of T1 code and selects long-type default write strategy or a short-type write strategy from the firmware when there is a write strategy only corresponding to the M code or when there is no write strategy corresponding to the M code.

According to the conventional method of determining a write strategy, the disc drive should include all write strategies for existing optical recordable discs and foreseeable future optical recordable discs. Further, the disc drive selects and applies default write strategy according to the T1 code of the disc, which indicates the type of material of the disc.

However, currently, optical recordable media, or discs, of different materials often require different driving speeds in order to function properly. Therefore, the conventional method of determining a write strategy may lead to at least a failure in recording or reproducing, a failure in power adjustment, or poor recording quality, due to inappropriate recording speed.

The invention provides a method of determining an optimum write strategy for an optical medium, which maintains recording quality and/or meets a user's needs by limiting an uppermost recording velocity according to M, T1, or T2 codes read from the medium or optical disc.

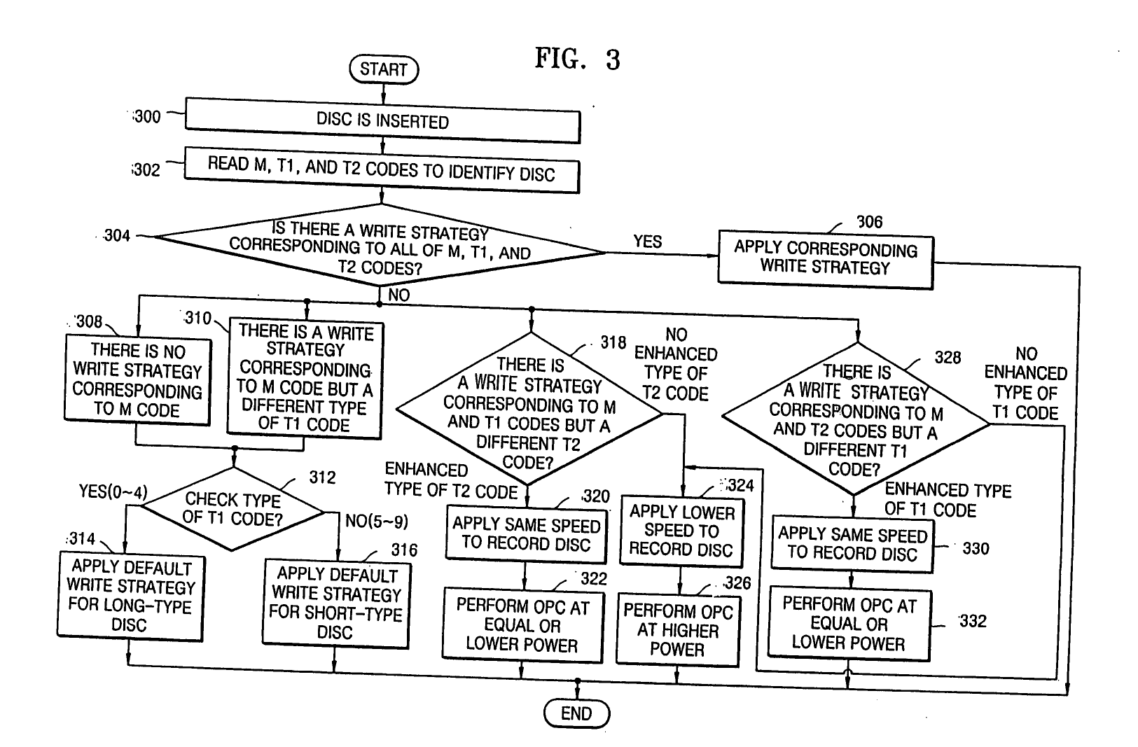

FIG. 3 is a flowchart illustrating a method of determining an optimum write strategy for an optical disc or medium according to an embodiment of the invention.

It is understood that a variety of write strategies for mediums that are manufactured by well-known manufacturers and/or are manufactured using a well-known type of material, are included in firmware of a disc drive.

A medium is inserted into the disc drive, as shown in operation 300.

The disc drive reads at least M, T1, and T2 codes from the medium, and identifies the medium from the read codes, as shown in operation 302.

The disc drive determines whether the M, T1, and T2 codes read from the medium are included in the firmware, as shown in operation 304. When all the same read codes are included in the firmware, the disc drive applies a write strategy corresponding to the codes, as shown in operation 306.

When all of the read codes M, T1, and T2 are not included in the firmware, the disc drive sets a write strategy according to one according to one of the following six scenarios:
1) Scenario 1—there is no write strategy corresponding to the same M code in the firmware of the disc drive, as shown in operation 308.
2) Scenario 2—there is a write strategy corresponding to the same M code but a different T1 code in the firmware of the disc drive, and the different T1 code is a different type from the T1 code read from the medium, as shown in operation 310.
3) Scenario 3—there is a write strategy corresponding to the same M and T1 codes but a different T2 code in the firmware of the disc drive, as shown in operation 318.
4) Scenario 4—there is a write strategy corresponding to the same M and T2 codes but a different T1 code in the firmware of the disc drive, as shown in operation 328.

When scenario 1 or 2 applies, the disc drive determines if a value of the T1 code read from the medium is in the range of 0 through 4, as shown in operation 312. When the value of the T1 code is in the range of 0 through 4, the disc drive selects and applies a default write strategy reserved for a long-strategy type medium, as shown in operation 314. When the value of the T1 code is not in the range of 0 through 4, the disc drive selects and applies a default write strategy reserved for a short-strategy type medium, as shown in operation 316.

In scenario 3, when the different T2 code is found to be an enhanced T2 code, the disc drive applies a predetermined driving speed set in the disc drive to record on the medium, as shown in operation 320. The disc drive then applies an OPC power no greater than a predetermined OPC power set in the disc drive for recording on the medium, as shown in operation 322. The enhanced T2 code may indicate, for example, that a recording characteristic of the medium is more enhanced than that of any other well-known type of medium or type of medium included in the firmware of the disc drive.

When the different T2 code is not determined to be an enhanced T2 code, which indicates that a recording characteristic of the medium is no better than that of any well-known type of medium, the disc drive applies a lower speed than the predetermined driving speed set in the disc drive for recording on the medium, as shown in operation 324. The disc drive then applies a higher OPC power than is set in the disc drive for recording on the medium, as shown in operation 326.

In scenario 4, when the different T1 code is determined to be an enhanced T1 code, which indicates a recording characteristic of the medium is more enhanced than that of any well-known medium, the disc drive applies a predetermined driving speed set in the disc drive to record on the medium, as shown in operation 330. The disc drive then applies an OPC power that is no greater than the predetermined OPC power set in the disc drive for recording the medium, as shown in operation 332. For example, the enhanced T1 code may indicate whether the recording characteristic of the medium is considerably more enhanced than any well-known medium.

When the different T1 code is not determined to be an enhanced T1 code, which indicates a recording characteristic of the medium is no better than that of any well-known type of medium, the disc drive performs operations 324 and 326.

As described above, according to the embodiments of the invention, a brand-new medium, which is not known to a disc drive but is made by known manufacturer included in the firmware, can be adaptively driven at an optimum driving speed and power by the disc drive.

According to another embodiment of the invention, the method and apparatus described above may be provided as computer-readable codes recorded on a recording medium accessible by at least one computer. Such recording media include various types of recording devices, such as ROM, RAM, CD-ROM, magnetic tape, hard discs, floppy discs, flash memory, optical data storage devices etc., in which computer-readable data can be stored. The recording media also include everything that is realized in the form of carrier waves, e.g., Internet transmission. In addition, the computer-readable codes may be accessed by computer systems connected to a network, and executed in a decentralized manner using a distribution method.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of determining an optimum recording speed for a medium in a disc drive device, the method comprising:
determining if disc characteristic information recorded on the medium is registered in the disc drive device, the disc characteristic information includes a manufacturer code and a type code; and
controlling a maximum recording speed and a target optimum power control power for recording on the medium according to the type code of the medium when the disc characteristic information is not determined to be registered in the disc drive device.

2. The method of claim 1, wherein when the type code of the medium is determined to be enhanced, the maximum recording speed for the medium is set to a predetermined set recording speed.

3. The method of claim 2, wherein when the type code of the medium is determined to be enhanced, the target optimum power control power for the medium is set at a level that is less than or equal to a predetermined set optimum power control power.

4. The method of claim 1, wherein when the type code of the medium is not determined to be enhanced, the maximum recording speed for the medium is set to a level that is less than a predetermined set recording speed.

5. The method of claim 4, wherein when the type code of the medium is not determined to be enhanced, the target optimum power control is set to a level that is greater than or equal to a predetermined set optimum power control power.

6. A disc drive device that determines an optimum recording speed for a medium inserted in the disc drive device, comprising:
a storage unit that stores recording characteristic information for a plurality of types of registered storage media;
a unit to read the recording characteristic information recorded on the medium to determine whether the medium is one of the registered storage media; and
a controller that controls a write strategy for recording on the medium according to a code of the recording characteristic information when the recording characteristic information is not one of the registered storage media,
wherein a recording velocity of the medium is controlled according to at least one of read recording characteristic information.

7. The disc drive device of claim 6, wherein the write strategy of the medium is controlled by a maximum recording speed and/or a target optimum power control power.

8. The disc drive device of claim 7, wherein the recording characteristic information comprises a manufacturer code to identify a manufacturer of the medium, and a type code to identify a recording characteristic of the medium.

9. The disc drive device of claim 8, wherein the type code identifies the medium as either a long-strategy type medium or a short-strategy type medium.

10. The disc drive device of claim 8, wherein the type code comprises:
a first type code that indicates the material type of the medium to determine whether the medium is a short-strategy type medium or a long-strategy type medium; and
a second type code that indicates whether the medium has enhanced recording characteristics as compared with the plurality of types of registered storage media.

11. The disc drive device of claim 9, wherein the long-strategy type medium is a cyanine-type medium and the short-strategy type medium is a phthalocynine-type medium.

12. The disc drive device of claim 10, wherein the enhanced recording characteristic indicates that a particular recording characteristic of the medium is more enhanced than a same particular recording characteristic of any registered medium stored in the storage unit.

13. The disc drive device of claim 6, wherein when all of the read recording characteristic information of the medium are included in the storage unit, the controller sets a corresponding write strategy that is set in the disc drive device.

14. The disc drive device of claim 6, wherein the medium is an optical data storage disc having computer readable code to be read by at least one computer.

15. A method for determining an optimum recording speed of a medium inserted in a disc drive device, comprising:
recording characteristic information on the computer readable medium relating to at least one characteristic of the computer readable medium; and
controlling a write strategy for recording on the medium according to the characteristic information recorded on the computer readable medium when not all of the disc characteristic information is registered in the at least one computer,
wherein the characteristic information comprises a manufacturer code to identify a manufacturer of the computer readable medium and a type code to identify a recording characteristic of the computer readable medium.

16. The method for determining the optimum recording speed of claim 15, wherein the write strategy is controlled by setting a maximum recording speed and a target optimum power control power for recording on the computer readable medium.

17. The method for determining the optimum recording speed of claim 15, wherein the type code identifies the computer readable medium as either a long-strategy type medium or a short-strategy type medium.

18. The method for determining the optimum recording speed of claim 15, wherein the type code comprises:
a first type code that indicates the material type of the computer readable medium to determine whether the computer readable medium is a short-strategy type medium or a long-strategy type medium; and
a second type code that indicates whether the computer readable medium has enhanced recording characteristics as compared with the plurality of types of registered storage media.

19. The method for determining the optimum recording speed of claim 15, wherein the long-strategy type medium is a cyanine-type medium and the short-strategy type medium is a phthalocynine-type medium.

20. A medium comprising computer readable code affecting a write strategy, and determining an optimum recording speed, for a medium inserted in a disc drive device according to the method of claim 15.
